(19) United States
(12) Patent Application Publication
(10) Pub. No.: US 2017/0160814 A1
(43) Pub. Date: Jun. 8, 2017

(54) TACTILE FEEDBACK METHOD AND APPARATUS, AND VIRTUAL REALITY INTERACTIVE SYSTEM

(71) Applicant: Beijing Zhigu Rui Tuo Tech Co., Ltd., Beijing (CN)

(72) Inventors: Lin Du, Beijing (CN); Liang Zhou, Beijing (CN)

(21) Appl. No.: 15/348,145

(22) Filed: Nov. 10, 2016

(30) Foreign Application Priority Data
Dec. 4, 2015 (CN) 201510885281.8

(51) Int. Cl. G06F 3/01; G06K 9/00; G06F 3/0481

(52) U.S. Cl. CPC G06F 3/017; G06F 3/016; G06F 3/04815; G06K 9/00335

(57) ABSTRACT

The present application provides a tactile feedback method, comprising: determining, on skin of a user, a region where contact between the user and a content presented in virtual reality (VR) occurs; and generating, according to relevant information of the content presented in the VR, at least a first contact feedback in the region where the contact occurs. The present application further provides a tactile feedback apparatus and a VR interactive system. The technical solutions provided by embodiments of the present application are used to cause that it is unnecessary to use a VR interactive controller and it is also unnecessary to perform a tactile feedback in a large scope, thereby greatly reducing costs and energy consumption needed for generating a tactile feedback.

### CROSS REFERENCE TO RELATED APPLICATION

The present application is based on and claims the benefit of priority to Chinese Application No. 201510885281.8, filed on Dec. 4, 2015, the entire contents of which are incorporated herein by reference.

### TECHNICAL FIELD

The present application relates to the field of man-machine interactions, and in particular, to a tactile feedback method and apparatus, and a virtual reality interactive system.

### BACKGROUND

The virtual reality (VR) technology is an important direction of simulation technologies, and enables, by means of perceptive stimulation in multiple dimensions such as visual sense, hearing, tactility, and smell sense, a user to enter a virtual world different from a physical environment where the user is located. Ideal VR should possess all perceptive functions possessed by a person.

In a VR system, if a person sees a cup and intends to pick it up, however, because the cup is virtual, a hand of the person does not have a feeling of really touching the cup, but “passes through” the virtual cup.

In a conventional solution, to enable people to more appropriately feel a feeling similar to the foregoing feeling of touching the cup, generally, some vibratile contacts are mounted on a VR interactive controller (such as a glove, a joystick, or a handheld controller) to implement a tactile feedback.

However, such a conventional solution generally needs a VR interactive controller to serve as a medium and provides a tactile feedback on the entire VR interactive controller, which causes relatively high costs and relatively high energy consumption.

### SUMMARY

An objective of the present application is to provide a tactile feedback method and apparatus, and a VR interactive system.

According to a first aspect of at least one embodiment of the present application, a tactile feedback method is provided, which comprises:

determining, on skin of a user, a region where contact between the user and a content presented in virtual reality (VR) occurs; and

generating, according to relevant information of the content presented in the VR, at least a first contact feedback in the region where the contact occurs.

According to a second aspect of at least one embodiment of the present application, a tactile feedback apparatus is provided, which comprises:

a contact determining module, configured to determine, on skin of a user, a region where contact between the user and a content presented in virtual reality (VR) occurs; and

a tactile feedback module, configured to generate, according to relevant information of the content presented in the VR, at least a first contact feedback in the region where the contact occurs.

According to a third aspect of at least one embodiment of the present application, a VR interactive system is provided, which comprises a memory and a processor, wherein the memory is configured to store an instruction; and the processor is configured to execute the instruction to execute the following steps:

determining, on skin of a user, a region where contact between the user and a content presented in virtual reality (VR) occurs; and

generating, according to relevant information of the content presented in the VR, at least a first contact feedback in the region where the contact occurs.

With regard to the tactile feedback method and apparatus, and the VR interactive system in embodiments of the present application, at least a first contact feedback is generated, according to relevant information of the content presented in the VR, in the region where the contact between the user and the content represented in the VR occurs. Therefore, it is unnecessary to use a VR interactive controller and it is also unnecessary to perform a tactile feedback in a large scope, thereby greatly reducing costs and energy consumption needed for generating a tactile feedback.

### BRIEF DESCRIPTION OF THE DRAWINGS

FIG. 1 is a flowchart of a tactile feedback method of an embodiment of the present application;

FIG. 2 is a flowchart of a tactile feedback method of another embodiment of the present application;

FIG. 3 is a flowchart of a tactile feedback method of another embodiment of the present application;

FIG. 4 is a schematic diagram of a specific implementation of a tactile feedback provided by an embodiment of the present application;

FIG. 5a is a flowchart of a tactile feedback method of another embodiment of the present application;

FIG. 5b is a schematic diagram of a specific implementation of determining a relative movement region in an embodiment of the present application;

FIG. 6 is a flowchart of a tactile feedback method of another embodiment of the present application;

FIG. 7 is a schematic structural diagram of modules of a tactile feedback apparatus of an embodiment of the present application;

FIG. 8 is a schematic structural diagram of modules of a tactile feedback apparatus of another embodiment of the present application;

FIG. 9 is a schematic structural diagram of modules of a tactile feedback apparatus of another embodiment of the present application;

FIG. 10 is a schematic structural diagram of modules of a tactile feedback apparatus of another embodiment of the present application;

FIG. 11 is a schematic structural diagram of a relative movement determining sub-module 721 of an embodiment of the present application;

FIG. 12 is a schematic structural diagram of modules of a tactile feedback apparatus of another embodiment of the present application; and

FIG. 13 is a schematic diagram of a VR interactive system provided by an embodiment of the present application.

### DETAILED DESCRIPTION

Specific implementations of the present application are further described in detail below with reference to the accompanying drawings and embodiments. The following embodiments are intended to describe the present application, but not to limit the scope of the present application.

It should be understood by a person skilled in the art that in embodiments of the present application, the value of the serial number of each step does not mean an execution sequence, and the execution sequence of each step should be determined according to the function and internal logic thereof, and should not be any limitation on the implementation procedure of the specific embodiments of the present application.

In addition, the terms “first”, “second”, and the like in the present application are merely used to distinguish different steps, devices, modules, or the like, and neither represent any special technical meaning, nor represent a necessary logical sequence therebetween.

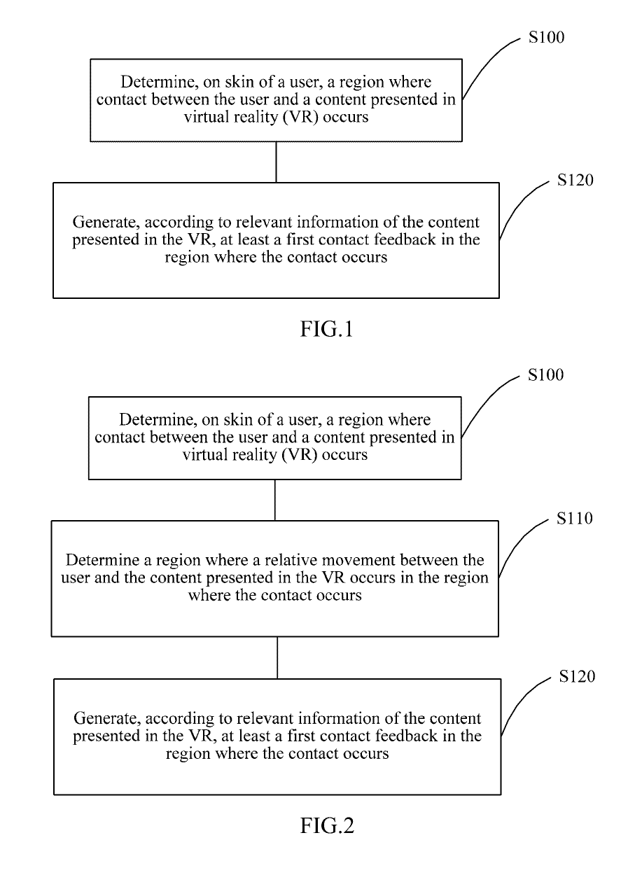

FIG. 1 is a flowchart of a tactile feedback method of an embodiment of the present application. As shown in FIG. 1, the method can comprise:

S100: Determine, on skin of a user, a region where contact between the user and a content presented in virtual reality (VR) occurs.

S120: Generate, according to relevant information of the content presented in the VR, at least a first contact feedback in the region where the contact occurs.

The tactile feedback method in the embodiments of the present application is used, wherein at least a first contact feedback is generated, according to relevant information of the content presented in the VR, in the region where the contact between the user and the content represented in the VR occurs. Therefore, it is unnecessary to use a VR interactive controller and it is also unnecessary to perform a tactile feedback in a large scope, thereby greatly reducing costs and energy consumption needed for generating a tactile feedback.

Optionally, as shown in FIG. 2, after the foregoing S100, the method may further comprise:

S110: Determine a region where a relative movement between the user and the content presented in the VR occurs in the region where the contact occurs.

In an optional implementation manner, a relative movement may occur between a hand of a user, a foot of the user or another body part of the user and the content presented in the VR, which is not specifically defined in the embodiments of the present application. In the region where the relative movement occurs, a relative distance between at least one part of the body of the user and the content presented in the VR is not a constant within a specific time, that is, a change occurs. Exemplarily, a transverse movement of the hand of the user occurs on a surface of the content presented in the VR, for example, the user pushes aside a virtually presented branch over the head; or the foot of the user applies a force in a vertical direction on the surface of the content presented in the VR to cause deformation on the surface of the content presented in the VR, for example, the user stamps a virtually presented football on the ground with a foot to cause that a surface of the football concaves down by a specific distance.

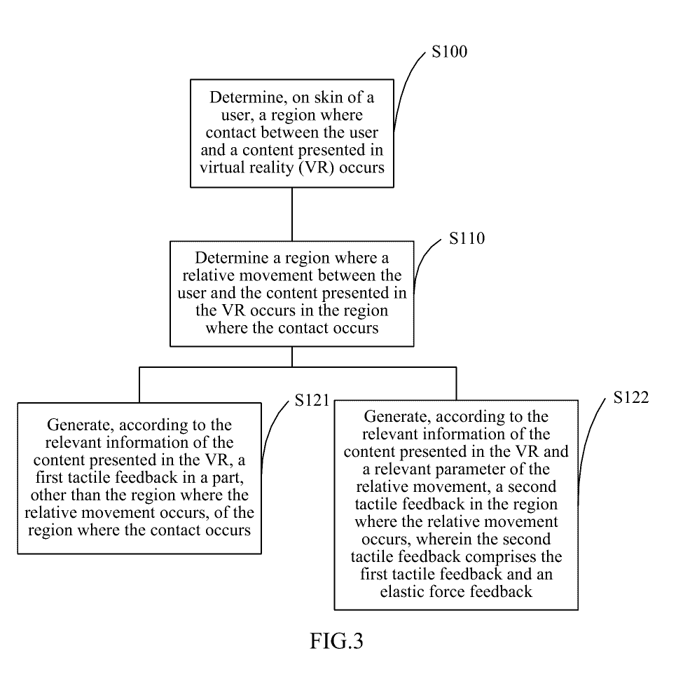

Optionally, as shown in FIG. 3, in another optional implementation manner of the present application, in S120, the generating, according to relevant information of the content presented in the VR, at least a first contact feedback in the region where the contact occurs may comprise:

S121: Generate, according to the relevant information of the content presented in the VR, the first tactile feedback in the part, other than the region where the relative movement occurs, of the region where the contact occurs.

Optionally, in an optional implementation manner of the present application, the relevant information of the foregoing content presented in the VR may comprise: attribute information of the foregoing content presented in the VR, for example, the presented content is what device, has what shape and thickness, is made of which material, is new or old, and has what pattern on the surface, and the like, which is not specifically defined in the embodiments of the present application.

S122: Generate, according to the relevant information of the content presented in the VR and a relevant parameter of the relative movement, a second tactile feedback in the region where the relative movement occurs, wherein the second tactile feedback comprises the first tactile feedback and an elastic force feedback.

Optionally, in an optional implementation manner of the present application, the parameter of the foregoing relative movement may comprise: a changing amount of the relative distance between at least one part of the body of the user and the content presented in the VR, or the time when the relative distance between the at least one part of the body of the user and the content presented in the VR changes, or the like, which is not specifically defined in the embodiments of the present application.

Because in the region where the relative movement occurs, an acting force and a reacting force are generated between the user and the content presented in the VR, in addition to the first tactile feedback, at least an elastic force feedback is provided.

Optionally, in an optional implementation manner of the present application, the foregoing first tactile feedback may comprise: a physical material feedback of the content presented in the VR and/or a texture feedback of the content presented in the VR. Exemplarily, the foregoing texture feedback may comprise a combination of one or more of the following feedbacks: a concave-convex feeling feedback and a sticky feeling feedback.

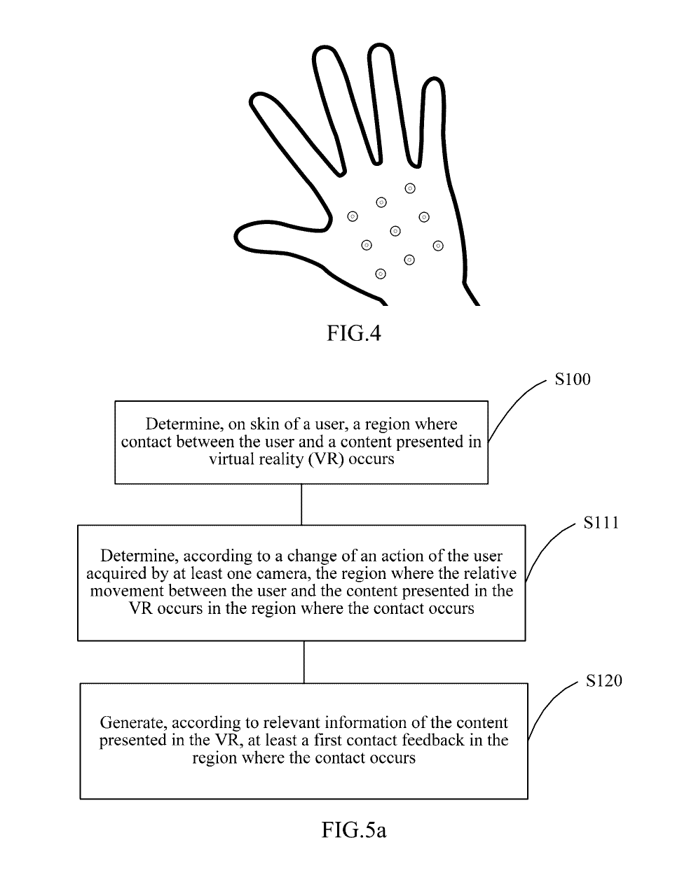

In a specific implementation, an external signal can be received, which, for example, may be an ultrasound or compressed air signal generated by at least one tactile feedback sensor distributed in the space. By means of a field effect generated by the external signal, the foregoing first tactile feedback and/or the foregoing second tactile feedback is generated on the skin of the user, as shown in FIG. 4.

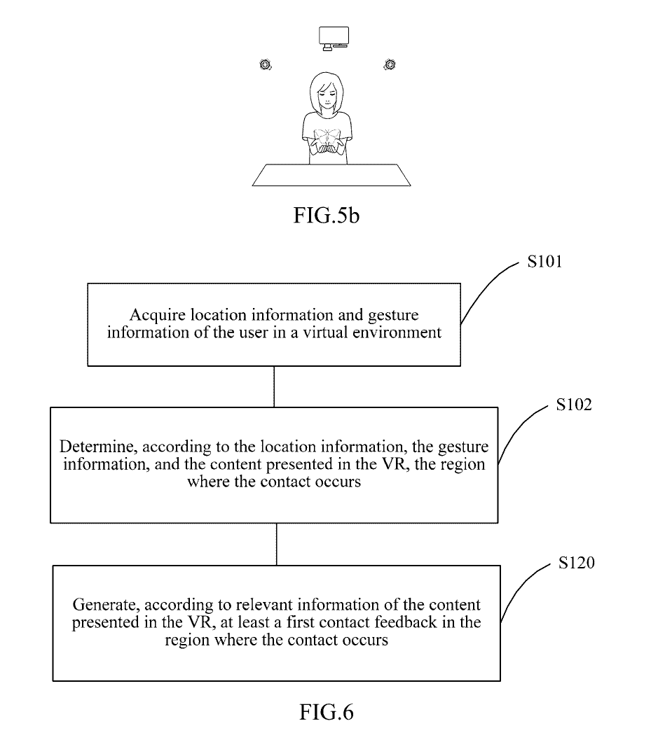

Optionally, as shown in FIG. 5a, in another optional implementation manner of the present application, in S110, the determining a region where a relative movement between the user and the content presented in the VR occurs in the region where the contact occurs may comprise:

S111: Determine, according to a change of an action of the user acquired by at least one camera, the region where the relative movement between the user and the content presented in the VR occurs in the region where the contact occurs.

Exemplarily, as shown in FIG. 5b, the user can be photographed by at least one camera distributed in the space, and a static picture or a moving image of the user collected by the at least one camera is analyzed; the change of the action of the user is determined (for example, a 3D depth map of the profile of the user can be determined); and the region where the relative movement between the user and the content presented in the VR occurs is determined, according to the change of the action of the user, in the region where the contact occurs.

Optionally, as shown in FIG. 6, in another optional implementation manner of the present application, in S100, the determining, on skin of a user, a region where contact between the user and a content presented in the VR occurs may comprise:

S101: Acquire location information and gesture information of the user in a virtual environment.

S102: Determine, according to the location information, the gesture information, and the content presented in the VR, the region where the contact occurs.

Exemplarily, because where the user is located can be determined according to the location information, and coordinates of different parts of the body of the user in the space can be determined according to the gesture information, if the location and gesture information of the user in the virtual environment are acquired, whether the user is in contact with the virtual environment and which part is in contact may be known by referring to the content presented in the VR, so as to determine the foregoing region where the contact occurs.

Similarly, the foregoing location information and/or gesture information can also be acquired by using the at least one camera distributed in the space, which is not described again herein.

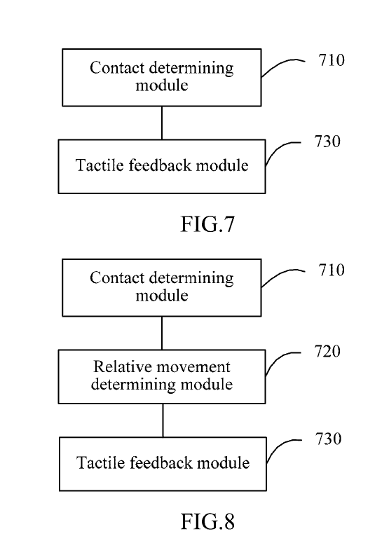

FIG. 7 is a schematic structural diagram of modules of a tactile feedback apparatus of an embodiment of the present application. The tactile feedback apparatus may be an independent physical device or may be one or more chips, a part of a circuit, or one or more functional modules. As shown in FIG. 7, the tactile feedback apparatus may comprise:

a contact determining module 710, configured to determine, on skin of a user, a region where contact between the user and a content presented in virtual reality (VR) occurs; and

a tactile feedback module 730, configured to generate, according to relevant information of the content presented in the VR, at least a first contact feedback in the region where the contact occurs.

The tactile feedback apparatus in the embodiments of the present application is used, wherein at least a first contact feedback is generated, according to relevant information of the content presented in the VR, in the region where the contact between the user and the content represented in the VR occurs. Therefore, it is unnecessary to use a VR interactive controller and it is also unnecessary to perform a tactile feedback in a large scope, thereby greatly reducing costs and energy consumption needed for generating a tactile feedback.

Optionally, as shown in FIG. 8, in an optional implementation manner, the tactile feedback apparatus 700 may further comprise:

a relative movement determining module 720, configured to determine a region where a relative movement between the user and the content presented in the VR occurs in the region where the contact occur.

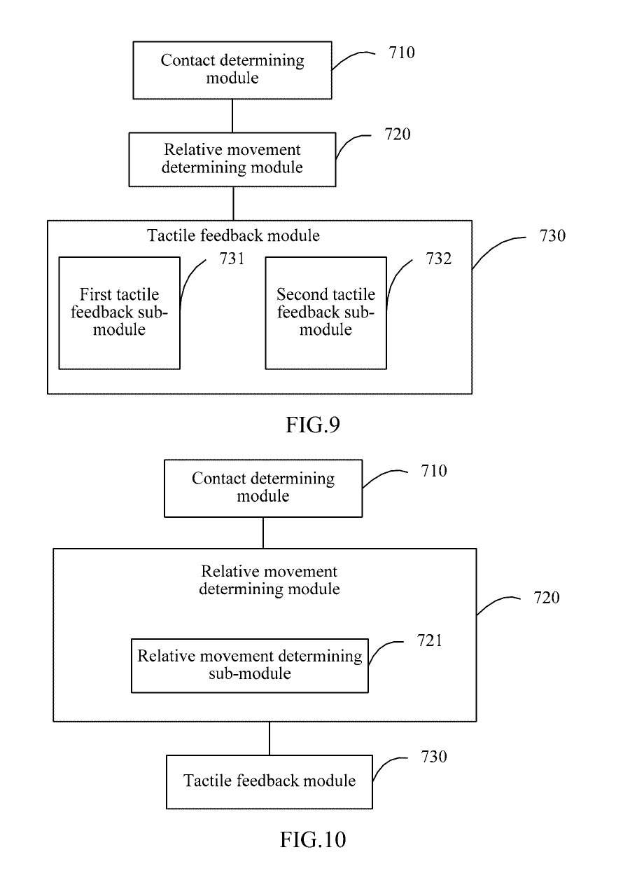

Optionally, as shown in FIG. 9, in an optional implementation manner, the tactile feedback module 730 may comprise:

a first tactile feedback sub-module 731, configured to generate, according to the relevant information of the content presented in the VR, the first tactile feedback in the part, other than the region where the relative movement occurs, of the region where the contact occurs; and

a second tactile feedback sub-module 732, configured to generate, according to the relevant information of the content presented in the VR and a relevant parameter of the relative movement, a second tactile feedback in the region where the relative movement occurs, wherein the second tactile feedback comprises the first tactile feedback and an elastic force feedback.

Optionally, as shown in FIG. 10, in an optional implementation manner, the relative movement determining module 720 may comprise:

a relative movement determining sub-module 721, configured to determine, according to a change of an action of the user acquired by at least one camera, the region where the relative movement between the user and the content presented in the VR occurs in the region where the contact occurs.

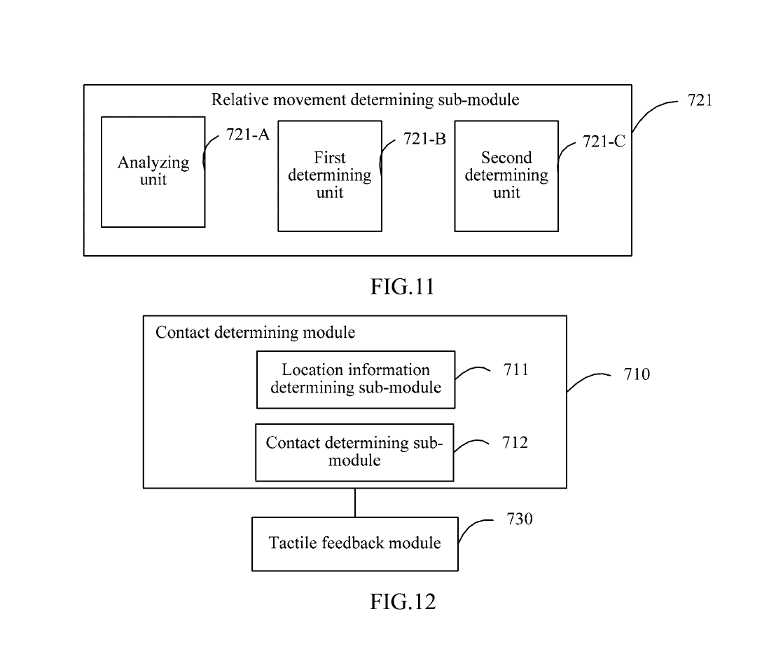

In a specific implementation, as shown in FIG. 11, the relative movement determining sub-module 721 may comprise:

an analyzing unit 721-A, configured to analyze a static picture or a moving image of the user collected by the at least one camera;

a first determining unit 721-B, configured to determine the change of the action of the user; and

a second determining unit 721-C, configured to determine, according to the change of the action of the user, the region where the relative movement between the user and the content presented in the VR occurs in the region where the contact occurs.

Optionally, as shown in FIG. 12, in an optional implementation manner, the contact determining module 710 may comprise:

a location information determining sub-module 711, configured to acquire location information and gesture information of the user in a virtual environment; and

a contact determining sub-module 712, configured to determine, according to the location information, the gesture information, and the content presented in the VR, the region where the contact occurs.

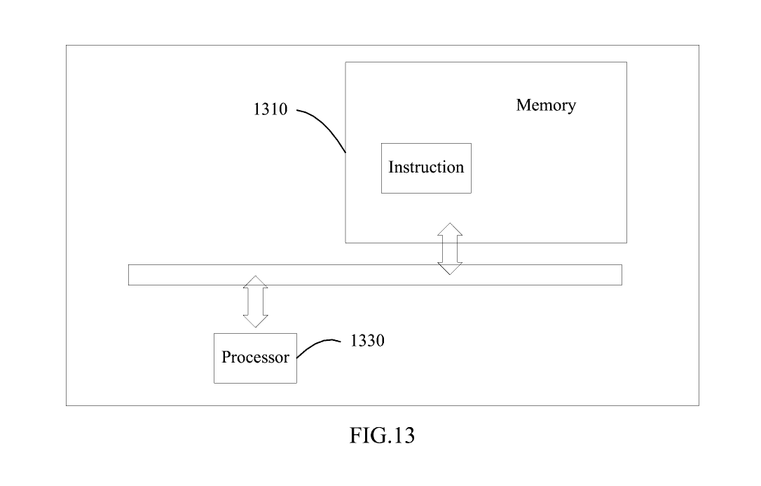

FIG. 13 is a schematic diagram of a VR interactive system provided by another embodiment of the present application. Referring to FIG. 13, the VR interactive system may comprise:

a memory 1310 and a processor 1330, wherein the memory 1310 is configured to store an instruction; and the processor 1330 is configured to execute the instruction to execute the following steps:

determining, on skin of a user, a region where contact between the user and a content presented in virtual reality (VR) occurs; and

generating, according to relevant information of the content presented in the VR, at least a first contact feedback in the region where the contact occurs.

Preferably, the memory 1310 and/or the processor 1330 can be integrated on the tactile feedback apparatus.

It may be clearly understood by a person skilled in the art that, for the purpose of convenient and brief description, reference may be made to description of corresponding procedures of the tactile feedback method in the foregoing method embodiments for detailed working procedures of the foregoing tactile feedback apparatus and VR interactive system, and the details are not further described herein.

In conclusion, the VR interactive system in the embodiments of the present application is used, wherein at least a first contact feedback is generated, according to relevant information of the content presented in the VR, in the region where the contact between the user and the content represented in the VR occurs. Therefore, it is unnecessary to use a VR interactive controller and it is also unnecessary to perform a tactile feedback in a large scope, thereby greatly reducing costs and energy consumption needed for generating a tactile feedback.

A person of ordinary skill in the art may be aware that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the existing art, or all or a part of the technical solutions may be implemented in the form of a software product. The software product is stored in a storage medium and comprises several instructions for instructing a computer device (which may be a personal computer, a controller, or a network device) or a processor to perform all or a part of the steps of the methods in the embodiments of the present application. Moreover, the foregoing storage medium comprises: any medium that can store program code, such as a USB flash drive, a removable hard disk, a read-only memory (ROM), a random access memory (RAM), a magnetic disk, or an optical disc.

The above implementations are only used to describe the present application, rather than limit the present application; various alterations and variants can be made by those of ordinary skill in the art without departing from the spirit and scope of the present application, so all equivalent technical solutions also belong to the scope of the present application, and the scope of patent protection of the present application should be defined by claims.

What is claimed is:

1. A tactile feedback method, comprising:
determining, on skin of a user, a region where contact between the user and a content presented in virtual reality (VR) occurs; and
generating, according to relevant information of the content presented in the VR, at least a first contact feedback in the region where the contact occurs.

2. The method of claim 1, wherein after the region where the contact occurs is determined, the method further comprises:
determining a region where a relative movement between the user and the content presented in the VR occurs in the region where the contact occurs.

3. The method of claim 2, wherein the generating, according to relevant information of the content presented in the VR, at least a first contact feedback in the region where the contact occurs comprises:
generating, according to the relevant information of the content presented in the VR, the first tactile feedback in the part, other than the region where the relative movement occurs, of the region where the contact occurs; and
generating, according to the relevant information of the content presented in the VR and a relevant parameter of the relative movement, a second tactile feedback in the region where the relative movement occurs, wherein:
the second tactile feedback comprises the first tactile feedback and an elastic force feedback.

4. The method of claim 2, wherein the determining a region where a relative movement between the user and the content presented in the VR occurs in the region where the contact occurs comprises:
determining, according to a change of an action of the user acquired by at least one camera, a region where a relative movement between the user and the content presented in the VR occurs in the region where the contact occurs.

5. The method of claim 4, wherein the determining, according to a change of an action of the user captured by at least one camera, a region where a relative movement between the user and the content presented in the VR occurs in the region where the contact occurs comprises:
analyzing a static picture or a moving image of the user collected by the at least one camera;
determining the change of the action of the user; and
determining, according to the change of the action of the user, the region where the relative movement between the user and the content presented in the VR occurs in the region where the contact occurs.

6. The method of claim 1, wherein the determining, on skin of a user, a region where contact between the user and a content presented in VR occurs comprises:
acquiring location information and gesture information of the user in a virtual environment; and
determining, according to the location information, the gesture information, and the content presented in the VR, the region where the contact occurs.

7. The method of claim 1, wherein the first tactile feedback comprises:
a physical material feedback of the content presented in the VR and/or a texture feedback of the content presented in the VR.

8. The method of claim 7, wherein the texture feedback comprises at least one of the following feedbacks:
a concave-convex feeling feedback and a sticky feeling feedback.

9. A tactile feedback apparatus, comprising:
a contact determining module, configured to determine, on skin of a user, a region where contact between the user and a content presented in virtual reality (VR) occurs; and
a tactile feedback module, configured to generate, according to relevant information of the content presented in the VR, at least a first contact feedback in the region where the contact occurs.

10. The apparatus of claim 9, wherein the apparatus further comprises:
a relative movement determining module, configured to determine a region where a relative movement between the user and the content presented in the VR occurs in the region where the contact occurs.

11. The apparatus of claim 10, wherein the tactile feedback module comprises:
a first tactile feedback sub-module, configured to generate, according to the relevant information of the content presented in the VR, the first tactile feedback in the part, other than the region where the relative movement occurs, of the region where the contact occurs; and
a second tactile feedback sub-module, configured to generate, according to the relevant information of the content presented in the VR and a relevant parameter of the relative movement, a second tactile feedback in the region where the relative movement occurs, wherein:
the second tactile feedback comprises the first tactile feedback and an elastic force feedback.

12. The apparatus of claim 10, wherein the relative movement determining module comprises:
a relative movement determining sub-module, configured to determine, according to a change of an action of the user acquired by at least one camera, a region where a relative movement between the user and the content presented in the VR occurs in the region where the contact occurs.

13. The apparatus of claim 12, wherein the relative movement determining sub-module comprises:
an analyzing unit, configured to analyze a static picture or a moving image of the user collected by the at least one camera;
a first determining unit, configured to determine the change of the action of the user; and
a second determining unit, configured to determine, according to the change of the action of the user, the region where the relative movement between the user and the content presented in the VR occurs in the region where the contact occurs.

14. The apparatus of claim 9, wherein the contact determining module comprises:
a location information determining sub-module, configured to acquire location information and gesture information of the user in a virtual environment; and
a contact determining sub-module, configured to determine, according to the location information, the gesture information, and the content presented in the VR, the region where the contact occurs.

15. A virtual reality (VR) interactive system, comprising a memory and a processor, wherein the memory is configured to store an instruction; and the processor is configured to execute the instruction to execute the following steps:
determining, on skin of a user, a region where contact between the user and a content presented in virtual reality (VR) occurs; and
generating, according to relevant information of the content presented in the VR, at least a first contact feedback in the region where the contact occurs.
